(19) United States
(12) Patent Application Publication
(10) Pub. No.: US 2025/0354737 A1
(43) Pub. Date: Nov. 20, 2025

(54) CONTROL SYSTEM FOR VAPOUR COMPRESSION CYCLE AND RELATED METHODS

(71) Applicant: Sunswap Ltd, Leatherhead Surrey (GB)

(72) Inventors: Adam Payne, Leatherhead Surrey (GB); Nikolai Tauber, Leatherhead Surrey (GB)

(73) Assignee: Sunswap Ltd, Leatherhead Surrey (GB)

(21) Appl. No.: 18/874,005

(22) PCT Filed: May 18, 2023
(86) PCT No.: PCT/EP2023/063430

§ 371 Date: Dec. 11, 2024

(30) Foreign Application Priority Data
Jun. 14, 2022 (GB) 2208715.9

(51) Int. Cl. F25B 49/02; F25D 11/00

(52) U.S. Cl. CPC F25B 49/022; F25D 11/003; F25B 2600/025

(57) ABSTRACT

Computerised methods of controlling a vapour compression cycle system. In a first aspect, the method comprises determining a cooling or heating power demand value based on the prevailing temperature and comparing (730) it with a required set point temperature. The power demand value is converted to a speed demand value according to a model or map (720) and according to evaporating and condensing pressure/temperature, which is sent to the compressor motor speed controller (70). In another aspect, the power demand value for hysteresis control to maintain the temperature is dynamically chosen (710) from a plurality of possible power demand values according to evaporating and condensing pressure/temperature and according to a measure of efficiency calculated for each candidate power demand value. In another aspect, a compressor capacity value is selected (930) by looking up a compressor capacity in a look up table according to evaporating and condensing pressure/temperature.

The present invention relates to a control system for a vapour compression cycle systems and related methods and software. This may be a refrigeration unit, as well as a heat pump or other heating systems.

Vapour compression cycles move heat from one compartment or area to another to provide cooling, in the case of a refrigeration unit, or heating, in the case of a heating unit and possibly both, i.e. in the case of a HVAC (Heating Venting Airconditioning) unit. A vapour compression cycle system typically consists of four primary components: evaporator, compressor, condenser, and expansion valve. When the compressor is driven, these combine to chill or heat air in one or more compartments. Fans are also driven to distribute the air. A controller is provided to control the operation of these components and typically to realise a set point temperature for the compartment or area to be cooled/heated.

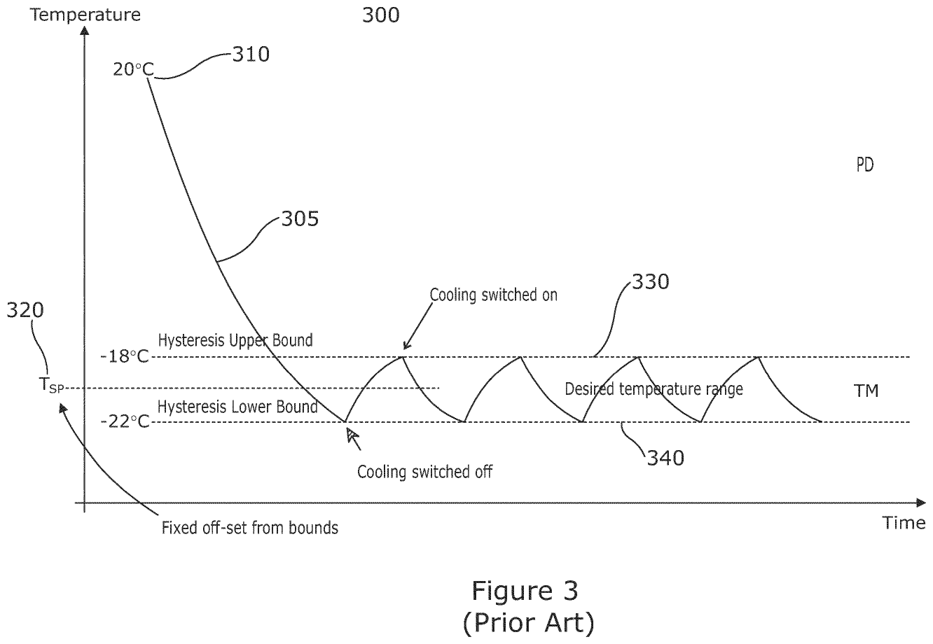

Hysteresis temperature control is common with such systems. FIG. 3 shows a typical temperature profile over time for a classic hysteresis control strategy implemented by the controller for a refrigeration unit. When the unit is switched on, the cooling is switched on to pull down the temperature in the compartment from the initial, ambient temperature 310 to reach the desired operating or set-point temperature Tsp 320. This is the Pull Down (PD) range of temperatures. Upper and lower hysteresis bounds 330,340 are created at predetermined offsets above and below the desired set point temperature, creating a Temperature Maintenance TM range. When the temperature 305 in the compartment falls to the lower bound 330, the cooling is switched off. When the temperature rises to the upper bound 340, the cooling is switched back on to cool the compartment. The on/off control sequence repeats to maintain the temperature in the range of acceptable temperatures anchored on the set point temperature. Additional pull down steps may be required. For instance, where the vapour compression cycle system is part of a Transport Refrigeration Unit, e.g. for cooling the interior compartment of a trailer to cool food or other good within, there may be sudden rises of the temperature following door open events, e.g. where a delivery has been made part way through a journey, allowing chilled air to escape and suddenly causing the interior temperature to rise outside the bounded TM range.

On/off control is usually preferred, rather than making any attempt to modulate the cooling power, as the refrigeration system normally delivers too much power and throttling down to lower power is inefficient or not possible due to system constraints, e.g. oil circulation requirements or minimum compressor speed requirements.

Typically, the cooling is provided at one or more various fixed compressor speeds throughout the process. However, this may lead to inefficiencies because the refrigeration cycle is made to operate outside its optimum operating point, as the individual components (motor controller, motor, compressor) of the refrigeration unit cannot operate at peak efficiency simultaneously. The optimum operating point depends a number of factors including motor controller current, motor speed and torque and compressor speed, evaporating and condensing pressure. The evaporating and condensing pressure is governed by evaporating and condensing temperatures, and these are in turn primarily dependent on the ambient and controlled temperature.

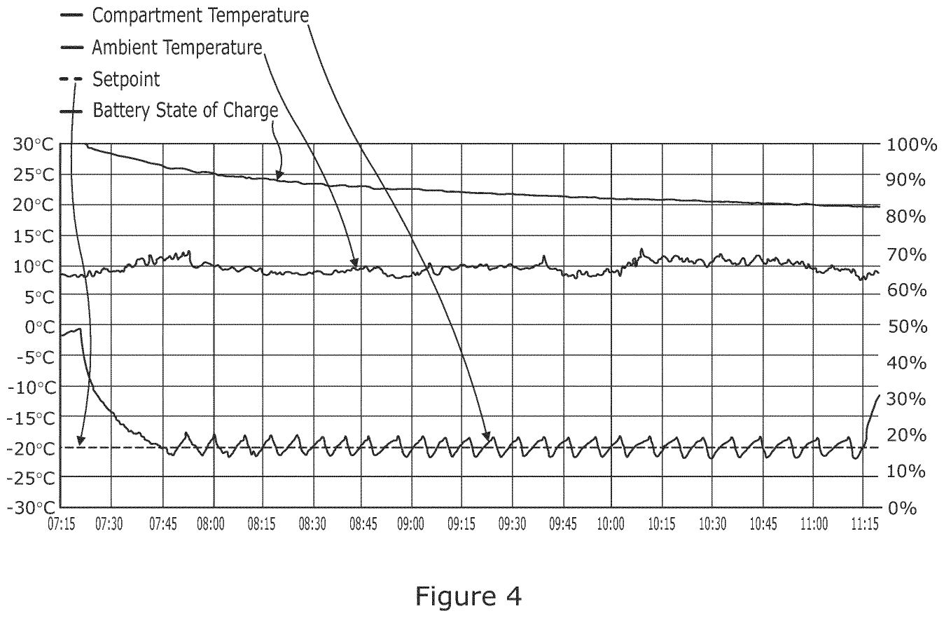

FIG. 4 shows a plot of compartment temperature, ambient temperature and battery state of charge for an example of a journey made by a truck and trailer equipped with a TRU using hysteresis control.

The present invention aims to address these and other problems in the prior art.

According to a first aspect of the present invention, there is provided a computerised method of controlling a vapour compression cycle arranged to cool and or heat a compartment, the method comprising:
dynamically determining a cooling or heating power demand value for the system based at least on part on monitoring the temperature in the compartment to be cooled or heated by the system and comparing it with a required set point temperature;
converting the power demand value to a speed demand value according to a predetermined model or map and according to prevailing values of evaporating pressure and condensing pressure, or the equivalent temperature values;
sending the speed demand value to a compressor motor speed controller of the system.

The method, e.g. when performed by a system controller of the vapour compression cycle system, controls the compressor of the system by determining the cooling or heating power demand before converting this to a speed demand value which is output to the compressor motor speed controller of the system. Prior art controllers typically control the compressor motor speed directly, which provide various cooling outputs dependent on the prevailing conditions, e.g. temperatures and pressures, meaning that it is difficult to modulate the desired output in cooling or heating effectively. Controlling power demand directly before converting to a speed demand in a second step provides finer control over the system. Speed control is an in-direct control method with a non-linear relationship to the physical thermal system being controlled. Cooling power demand control is a direct control method with a linear relationship to the physical thermal system being controlled. The benefit from Q control opposed to RPM control is that Q control allows controlling a property that impacts the system consistently in its complete operating envelope.

For example, during pull-down, Q control allows consistently outputting Qmax (e.g. 10 kW) which the refrigeration system is designed for. RPM control would mean outputting various fixed speeds throughout pulldown (e.g. 2600 RPM until TM is reached and then 1800 RPM). The cooling power would be vastly different throughout the pull-down exceeding evaporator and condenser capacity and in turn operating in-efficiently.

If direct RPM control was used to, say, determine RPMopt (optimum speed) value, a subsequently step would be needed to calculate or lookup what the cooling would be and if it was sufficient. It would also make RPMmin control dependent on pressures to “check” if the downstream cooling power is sufficient.

The system may be a refrigeration unit arranged to cool the compartment or heat pump arranged to heat the compartment. Compartment may be for instance the interior of a vehicle or room or building, in the case of air conditioning, heat pump or HVAC systems, or a trailer or other transportable container in the case of a transport refrigeration unit.

The model may be for instance, dynamically run as part of the computerised method or predetermined values stored in a look up table.

The power demand value may be selected from a plurality of predetermined discrete values. These for instance can be stored in look up table providing optimum values for given values of the prevailing evaporating pressure and condensing pressure. This is the cooling or heating power which means amount of heat removal/addition per unit of time

The power demand value may be dynamically chosen from a plurality of possible power demand values according to prevailing values of evaporating pressure and condensing pressure or equivalent temperature values or other proxies and according to a measure of efficiency calculated for each candidate power demand value. Evaporating pressure is the low side pressure, sometimes referred to as the suction pressure or back pressure. Condensing pressure is the high side pressure, sometimes referred to as the discharge pressure or head pressure. Values of system efficiency can be calculated by modelling or measure by testing.

The method may comprise in a temperature maintenance mode, using hysteresis control of the system to maintain the temperature in a range between upper and lower temperature bounds that are at predetermined offsets from a required set point temperature, wherein, if the compartment is to be cooled, the cooling is switched on using the speed demand value when the temperature rises to the upper bound and switched off when the temperature falls to the lower bound and, if the compartment is to be heated, the heating is switched on using the speed demand value when the temperature falls to the lower bound and switched off when the temperature rises to the upper bound. Where hysteresis control is used, the actual power demand value is not particularly important, in that various options may be available that can keep the temperature oscillating between the upper and lower bounds, with the speed at which this occurs not being particularly important. This gives scope for evaluating which demand value is most efficient for the system as a whole and selecting the appropriate power demand value, which is then converted to speed demand values for controlling the compressor motor drive.

The method may comprise
if the compartment is to be cooled, in a temperature pulldown mode, cooling with a fixed and/or maximum cooling power demand value, wherein temperature pulldown mode is used before entering the temperature maintenance mode; and
if the compartment is to be heated, in a temperature pullup mode, heating with a fixed and/or maximum heating power demand value, wherein the temperature pull up mode is used before entering the temperature maintenance mode.

Temperature pull down refers to an initial step aimed to quickly reduce the temperature to the set point range. This can be employed any time the temperature is above the upper bound or until it drops to the lower bound for the first time.

The method may comprise using a look up table of calculated or measured values to find the most efficient candidate power demand value for given values of evaporating pressure or condensing pressure or the equivalent temperature values.

The look up table can provide, for each combination of pressures, possible cooling power values and a coefficient of performance value (or other flag or metric) which indicates which power value is the most efficient and should be selected. The lookup table is preferably specific to the particular refrigeration unit, as the values depend on factors specific to the system being controlled. Alternatively the software may comprise a model of the system which can calculate optimum values on the fly. The efficiency value preferably combines the efficiencies of the individual components of the system, e.g. any combination of motor power converter, motor, compressor and fans.

In an embodiment, the candidate power demand values are selected between predetermined minimum and maximum values. These may be default values depending on the physical capabilities of the system, e.g. maximum speed for the compressor, maximum current for the motor drive, etc.

Preferably, the minimum power demand value is dynamically recalculated according to the difference between the set point temperature and actual temperature such that a higher value is selected where the difference is greater. This helps eliminate possible candidate power demand values which are insufficient to keep the temperature between the bounds even when the system is switched on continually but that otherwise might be selected as being the most efficient. Thus, this prevents any possible tendency for the temperature to drift outside the range based on the set point temperature by effectively increasing the minimum value of power demand that can be selected where the temperature is a long way from the set point. A feedback control scheme may be used to adjust the minimum value.

In an embodiment a moving average filter is applied to pressure readings or equivalent temperature readings before choosing the power demand value and/or the pressure readings are only used when the system is switched on.

In an embodiment, the method comprises converting the power demand value to a fan speed demand value according to a predetermined model or map and according to prevailing values of evaporator coil pressure drop; and controlling at least one fan of the system according to the fan speed demand value. Thus, once a power demand is determined it can be used to look up corresponding compressor and fan values. The fan speed is calculated based on the pressure drop over the evaporator coil. As it ices up the pressure drop will increase requiring a higher fan speed to blow the same amount of air for the same amount of cooling power.

In an embodiment the system comprises a compressor that can operate in at least a first and second capacity, the method comprising:
using the output power demand value and sensed values of evaporating pressure and condensing pressure or equivalent temperature values to output via a lookup table to an optimum compressor capacity;
output a control signal to cause the compressor to implement the selected optimum compressor capacity.

The method may comprise selecting a look up table for the selected compressor capacity from a plurality of look up tables for respective plural different compressor capacities, wherein each lookup table maps power demand values to compressor speed values and using that lookup table to select an output compressor speed signal to feed to the compressor motor speed controller. The capacity look up table and speed look up table may be combined, e.g. having two output values per look up of power demand, condenser pressure and evaporator pressure, or separate.

The lookup table may be constructed such that capacity is selected based on comparing a one or more values selected from compressor speed, system coefficient of performance and torque with predefined maximum and/or minimum values. Aspects of the invention may extend to constructing the lookup table for the control system in this way, either through modelling or experimentation. In an embodiment, full capacity is selected when: the full capacity torque is lower than maximum torque and full capacity speed is greater than minimum speed or half capacity speed is greater than maximum speed at half capacity and otherwise half capacity is selected. In an other embodiment, full capacity is selected when: the coefficient of performance at full capacity is higher than the coefficient of performance at half capacity and the full capacity speed is greater than the minimum speed allowed and otherwise half capacity is selected.

According to a second aspect of the invention, there is provided a computerised method of controlling a vapour compression cycle system arranged to cool and or heat a compartment, the method comprising:
monitoring the temperature in the compartment to be cooled or heated by the system;
in a temperature maintenance mode, using hysteresis control of the system to maintain the temperature in a range between upper and lower temperature bounds that are at predetermined offsets from a required set point temperature, wherein the power demand value used is dynamically chosen from a plurality of possible power demand values according to prevailing values of evaporating pressure and condensing pressure or equivalent temperature values and according to a measure of efficiency calculated for each candidate power demand value.

The method may comprise
if the compartment is to be cooled, in a temperature pulldown mode, cooling with a fixed and/or maximum cooling power demand value, wherein temperature pulldown mode is used before entering the temperature maintenance mode; and
if the compartment is to be heated, in a temperature pullup mode, heating with a fixed and/or maximum power demand value, wherein the temperature pull up mode is used before entering the temperature maintenance mode.

The method may comprise using a look up table of calculated or measured values to find the most efficient candidate power demand values for given values of evaporating pressure or condensing pressure.

In an embodiment, the candidate power demand values are selected between predetermined minimum and maximum values and wherein the minimum value is dynamically recalculated according to the difference between the set point temperature and actual temperature such that a higher value is selected for the minimum power demand value where the difference is greater.

According to a third aspect of the invention, there is provided a computerised method of controlling a vapour compression cycle system arranged to cool and or heat a compartment, the method comprising:
determining a cooling or heating power demand value; point
selecting a compressor capacity value by looking up a compressor capacity in a look up table according to prevailing evaporating and condensing pressures or their equivalent temperatures and the determined power demand value;
causing the compressor to operate in accordance with control signals comprising the compressor capacity value and power demand value.

The compressor capacity may be controlled by engaging different numbers of cylinders in the compressor and/or different numbers of compressors. For instance, the capacity may be full capacity where all cylinders of the compressor are engaged or half capacity where half of the cylinders are engaged. Similarly, the capacity may be full capacity where all (e.g. two) of the compressors are engaged, and half capacity where half (e.g. one of the two) compressors are engaged. The number of cylinders and the number of compressors engaged may be combined in any way, and more capacity options than full and half capacity may be provided as desired.

The method may comprise
monitoring the temperature in the compartment to be cooled or heated by the system;
comparing the temperature to a required set point temperature;
using a demand controller to determine the cooling or heating power demand value based on feeding back the difference between the monitored temperature and set point temperature configured to reduce the difference.

In an embodiment, the power demand value is dynamically chosen from a plurality of possible power demand values according to current prevailing values of evaporating pressure and condensing pressure or equivalent temperature values and according to a measure of efficiency calculated for each candidate power demand value.

The method may comprise converting the power demand value to a speed demand value according to the compressor capacity value.

In an embodiment a lookup table is used to map power demand values to speed demand values wherein the table is indexed by the power demand value, the capacity, and prevailing evaporating and condensing pressures or their equivalent temperatures.

In an embodiment the look up table values are generated by modelling the system or by testing.

The invention also extends to a refrigeration unit, transport refrigeration unit or heat pump comprising a vapour compression cycle system and a system controller arranged to perform the method described above.

It will be appreciated that any features expressed herein as being provided “in one example” or “in an embodiment” or as being “preferable” may be provided in combination with any one or more other such features together with any one or more of the aspects of the present invention.

Embodiments of the present invention will now be described by way of example with reference to the accompanying drawings, in which:

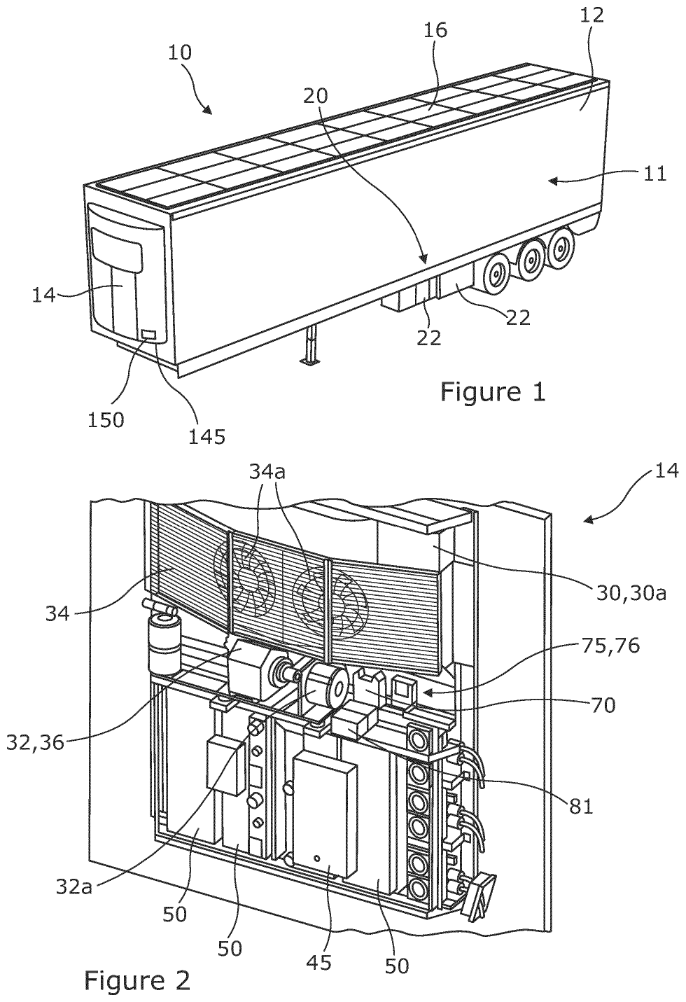

FIG. 1 shows a perspective view of an example of a refrigeration unit according to an embodiment of the present invention, in this example incorporated in a transport refrigeration unit attached to a trailer;

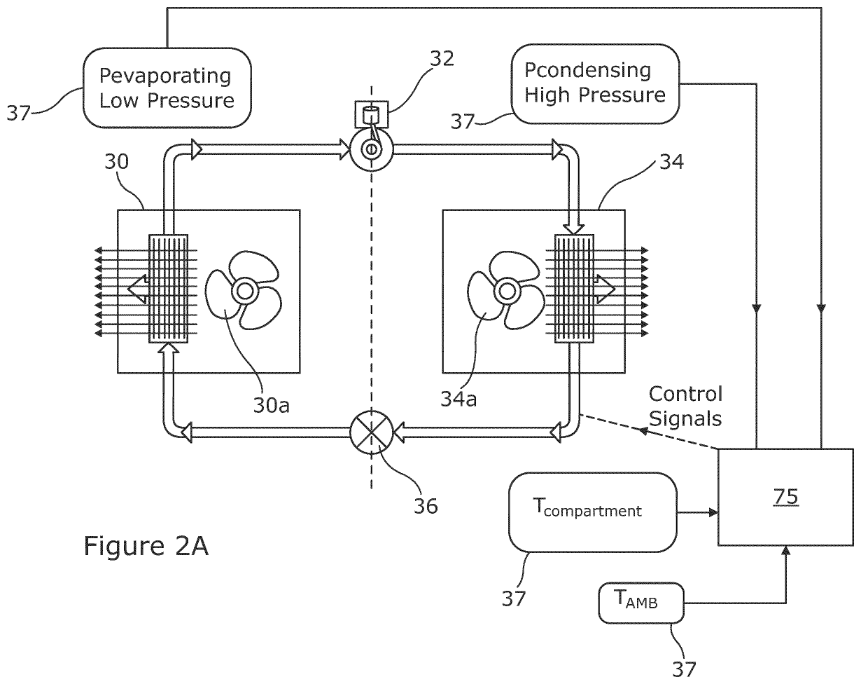

FIG. 2 shows a detailed view of the main unit of the refrigeration unit of FIG. 1;

FIG. 2A shows schematically the elements of a vapour compression cycle system as incorporated in the refrigeration unit;

FIG. 3 shows a typical known hysteresis control strategy for a refrigeration unit;

FIG. 4 shows the relationship between ambient temperature, compartment temperature and battery state of charge of battery powered TRU;

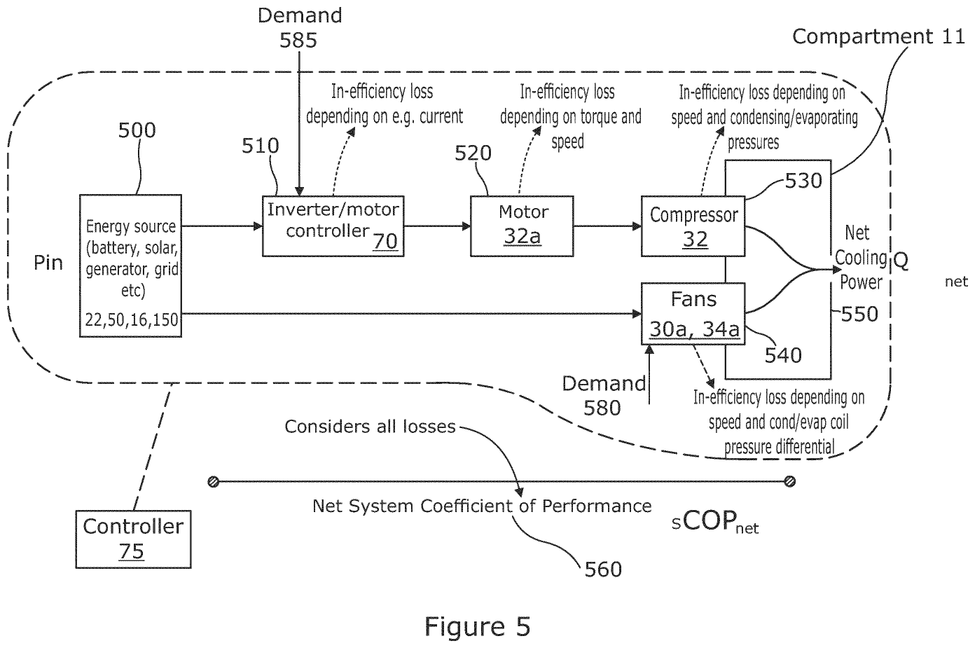

FIG. 5 shows an example of losses experienced by various components of the refrigeration unit;

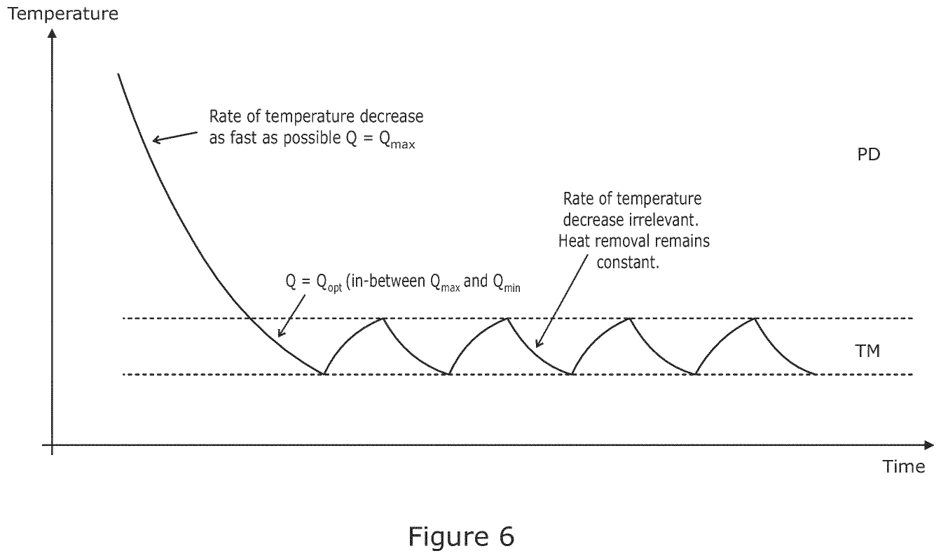

FIG. 6 shows an example of the temperature profile for a cooling power control scheme according to an embodiment of the present invention;

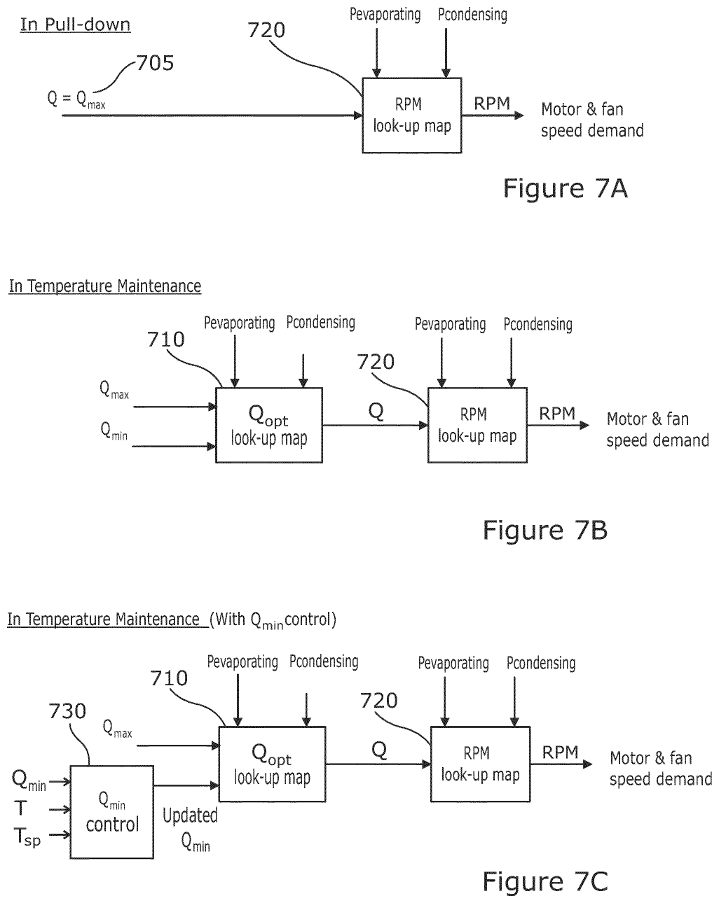

FIGS. 7a to 7c show examples of cooling power control to be implemented at different times;

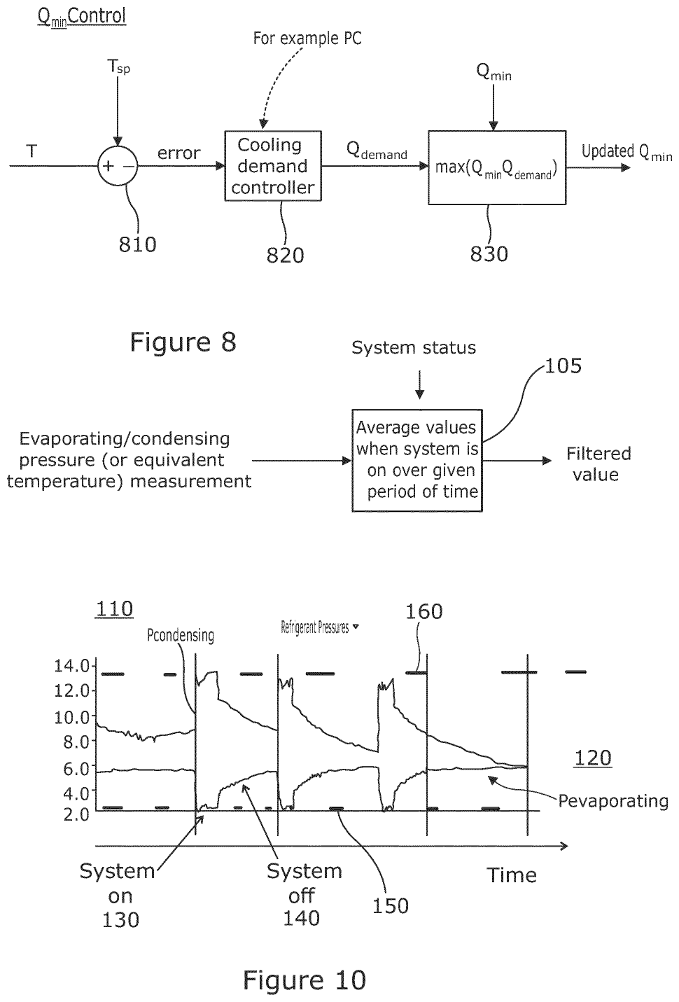

FIG. 8 shows a control scheme for updating Qₘᵢₙ;

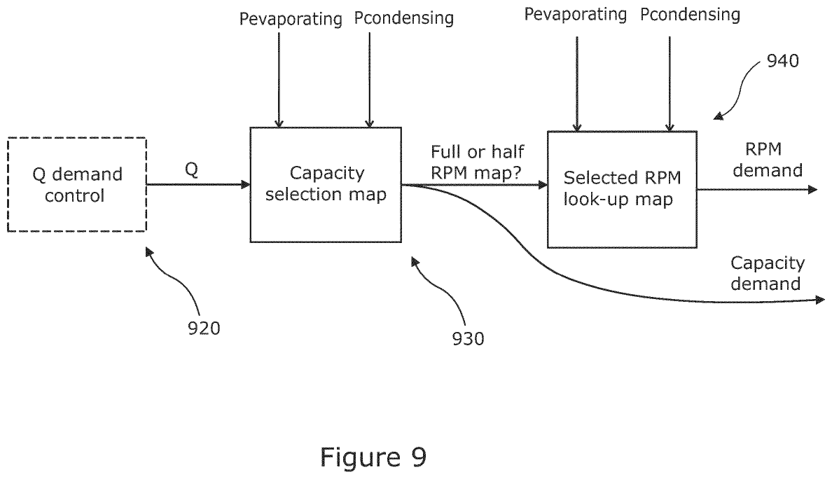

FIG. 9 shows another example of a control scheme;

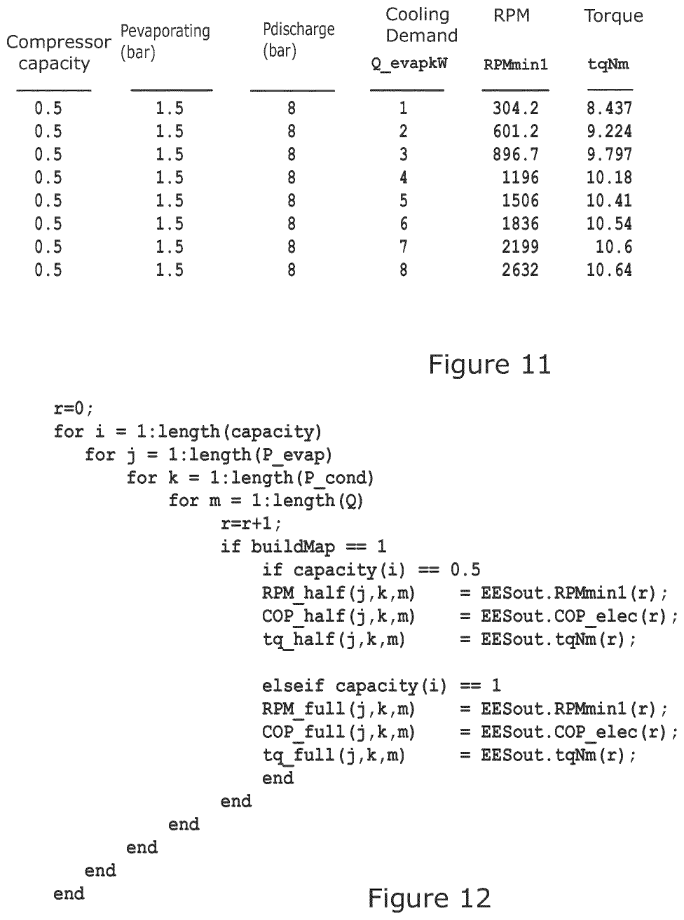

FIG. 10 shows refrigerant pressures;

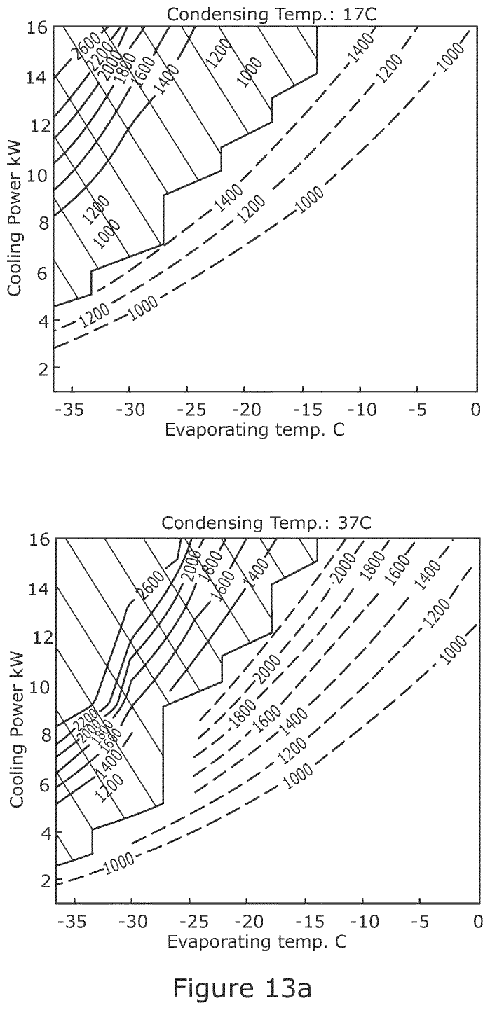

FIG. 11 shows an example of a look up table to be used with the above control scheme;

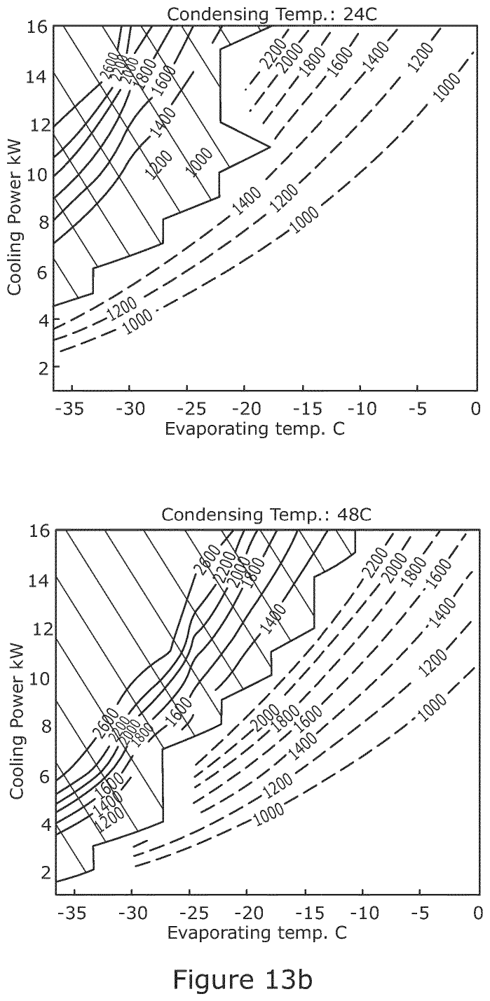

FIG. 12 shows pseudo code for building a table; and

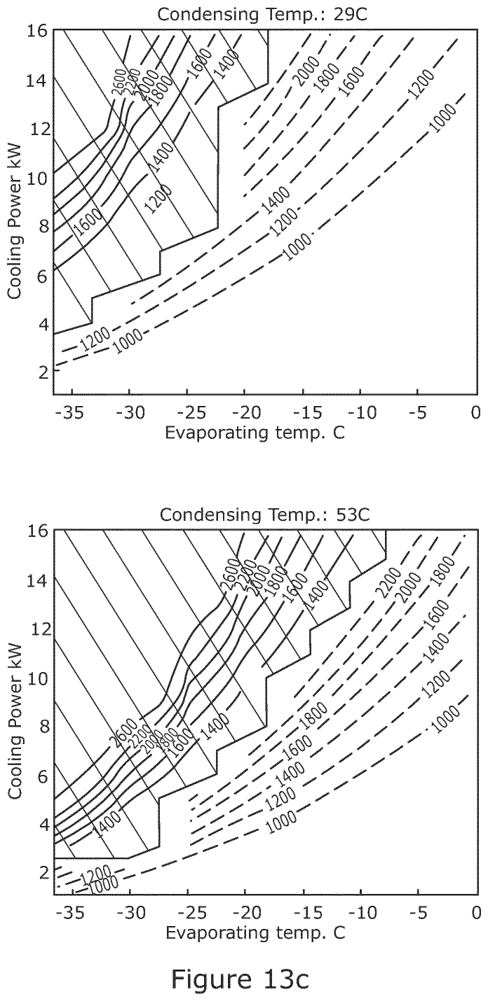

FIGS. 13a to 13c show plots of cooling temperature vs cooling power for different condensing temperatures.

FIG. 1 shows a perspective views of an example of a vapour compression cycle system in the form of a refrigeration unit 14 implementing a control system according to an embodiment of the invention. In this example, the refrigeration unit is provided as part of an electric Transport Refrigeration Unit (TRU) 10 integrated with a semi-trailer 12 of the sort that can be attached to and pulled by a tractor unit (not shown) to transport goods loaded to the interior of the trailer. The system is particularly well suited to use with battery powered refrigeration systems, as the greater efficiency achieved by the control system maximises the amount of cooling obtainable for a given battery charge level. However, it will be appreciated that the refrigeration unit can be of any type used to cool the interior of any compartment or enclosure, whether battery powered, mobile or otherwise. Similarly, it will be appreciated that the control system may be used to control a heat pump for heating a compartment or enclosed area or a liquid loop, e.g. a domestic heating system. The control system may be used with any vapour compression cycle system.

The TRU 10 comprises a main refrigeration unit 14, shown in more detail in FIG. 2, attached to the near end of the trailer 12 (with the doors 12a allowing access to the interior compartment 11 of the trailer being at the far end), as per known arrangements. The main unit 14 comprises the four primary components for the vapour compression cycle system, as shown by FIG. 2A, namely: an evaporator 30, a compressor 32, a condenser 34, and an expansion valve 36. When the compressor 32 is driven by its motor 32a, these combine to chill air in the interior compartment 11 of the trailer 12 to cool the contents. These are under the control of the system controller 75.

In the present example, the TRU 10 is powered electrically by one or more rechargeable batteries 50/22 and one or more solar panels 16 attached to the roof of the trailer 12. The batteries may be, for example, embedded in the main unit 14 TRU or in a battery rack 20 underneath the trailer. Other arrangements are possible.

The TRU 10 may also have a grid connector 145 for connecting to the grid 150 to provide power at the appropriate voltage level for powering the refrigeration system or charging the batteries when the trailer is parked for when solar power is insufficient.

An electrical system 45 of power electronics is provided, the primary purpose of which is to supply electric power from the power sources to drive the compressor motor and fans. Within the electrical system 45, the batteries are connected to various power controllers to manage delivery of power from the various power sources to the batteries and from the batteries and other sources to the power consuming devices. The compressor 32 in this example is powered by an AC output voltage provided by the motor controller 70 which alters the frequency of the AC power so as to vary the speed of the motor and thus the compressor under control of the system controller 75. Power is also selectively supplied to the fans 30a,34a of the evaporator 30 and condenser 34.

The system controller 75 comprises a processor for running stored software for implementing the various control processes described herein. The controller has communication links to the various elements of the TRU 10 to control and monitor the refrigeration process, i.e. to pull down and maintain a set point temperature. Various sensors 37 monitor temperature and pressure at various points in the cycle, both of the refrigerant and ambient air and air in the trailer compartment, as shown in FIG. 2A. The system controller 75 may also manage and monitor the various energy sources and electrical system 45 in connecting and supplying power to the various components.

The system controller 75 may include a Human Machine Interface, by which settings can be controlled locally by an operator, e.g. to turn on the unit and/or to supply a desired set point temperature for cooling. The system controller 75 may further be connected to or incorporate a wireless gateway (e.g. 4G) 76 by which it can exchange data with a software platform running on a remote server, e.g. in the cloud, allowing the software platform to monitor performance of the electrical system 45 and refrigeration system, and in particular monitor and control charging of the batteries in the TRU.

As discussed above, typical control strategies implemented by known system controllers for refrigeration systems, e.g. employing a simple hysteresis control scheme, can be inefficient.

FIG. 5 shows elements of a typical compressor drive train together with expected losses. At stage 500, the electrical sources, e.g. the battery 22,50, 16, 150, solar 16 and mains power 150 mentioned above, provide power to a motor controller 70, e.g. an inverter. At stage 510, the motor controller 510 converts the electrical power to a suitable form to drive the compressor motor 32a (e.g. a variable frequency drive), typically converting DC to various AC frequencies depending on the desired motor speed. At stage 520 the motor 32a develops output torque that drives the compressor 32 of the refrigeration unit. At stage 530, the compressor 32 compresses the refrigerant adding pump pressure to the evaporating pressure (the low side pressure also known as the suction pressure) to give rise to the condensing pressure (the high side pressure also known as the discharge pressure) that causes the refrigerant to circulate in the refrigeration system, chilling the air in the compartment via the evaporator and expelling the heat to the atmosphere via the condenser. At stage 540 the electrical sources also power the fans 30a,34a used to move the chilled air around the compartment and move air over the condenser.

At each stage, various losses arise depending on various factors that may be different for each element. For instance, at stage 510, the inverter/motor controller may suffer inefficiency losses depending on the current driving it. The controller controls the frequency for the motor and thus the speed, the compressor returns the torque demand (depending on pressures) and thus the current. At stage 520, the motor may suffer inefficiency losses depending on the torque and speed it is operating at. At stage 530, the compressor may suffer inefficiency loss if it is not operating at its optimum combination of speed and evaporating and condensing pressures. At stage 540, the fans may suffer inefficiency loss depending on speed and condenser/evaporator coil pressure differential, e.g. due to ice build-up.

In refrigeration systems, the Coefficient of Performance is a known measure of the efficiency of the system equating to the amount of heat removed from the compartment divided by the work done to remove the heat.

The Coefficient of Performance metric used in the present example is a net value in which the loses are accounted for and then the heat generated by the fans is offset from the gross amount of heat removed from the compartment to produce a net cooling power value Qₙₑₜ. A net system coefficient of performance (sCoPₙₑₜ) 560 is calculated by dividing the net cooling power Qₙₑₜ by the input power Pᵢₙ. Nonetheless, in other examples the gross value of the heat removed from the compartment could be used in calculating the system coefficient of performance instead which would be a workable approximation still giving good results.

In any event, a higher sCoP represents high efficiency (NB as used herein sCoP is system coefficient of performance, not seasonal coefficient of performance which is a measure sometimes used in refrigeration systems). In general, sCoP is highly dependent on operating conditions, especially the hot side (ambient) and cold side (compartment) temperatures, for which the pressure differential between evaporating and condensing pressure may act as a proxy.

Each individual component operates at a peak efficiency depending on various conditions. As the optimum conditions are unlikely to be the same for all components and so not simultaneously attainable for all components, this means all components can never operate at their individual peak efficiency at the same time. Accordingly, there is a combined optimum efficiency for the combined components which is less than the individual optimum efficiencies of the components combined.

For example, the compressor 32 could operate at its peak efficiency when the pressure differential is low and the speed is 1000 RPM (Revolutions per Minute). At higher pressure differentials the peak efficiency could be at 1500 RPM. A low pressure differential causes a low torque which may be below the peak motor efficiency point. On the other hand, a high pressure differential causes a high torque which may be above the peak motor efficiency point. Finally, the motor controller operates more efficiently at low torques.

Ultimately, for each combination of evaporating and condensing pressures there is a Net Cooling Power (Qₙₑₜ) output 550 that requires the least amount of input energy (Pin) per unit of cooling. This is the combined optimum and is the Peak Net System Coefficient of Performance 560 given by:

$$max ( {sCoP}_{net} ) = max ( \frac{{Q}_{net}}{{P}_{in}} )$$

Table 1 shows an example of mappings between pre-calculated or pre-measured Net Cooling Power (Qₙₑₜ) values and equivalent sCoPₙₑₜ values at a given pressure combination.

TABLE 1

| sCoPₙₑₜ at example | | |
|---|---|---|
| pressure combination | Pᵢₙ | Qₙₑₜ |
| 1.4 | 7.14 kW | 10 kW |
| 1.6 | 4.69 kW | 7.5 kW (Qₒₚₜ) |
| 1.5 | 3.33 kW | 5 kW |

The maximum sCoPₙₑₜ value is 1.6 which gives an optimum value for cooling Qₒₚₜ of 7.5 kW.

The system controller operates various algorithms to improve efficiency.

As shown by the cooling curve of FIG. 6, the algorithm uses different cooling strategies when pulling down the temperature to the set point range of temperatures (“Pull down” PD range of temperatures) and when maintaining the temperature at the set point range of temperatures (the “Temperature Maintenance” TM range).

This algorithm causes the cooling power demand Q to change from the maximum cooling to optimum cooling when transitioning from the “Pull Down” PD range to the “Temperature Maintenance” TM range.

As illustrated by FIG. 7A, in the “Pull-down” PD range, the highest available cooling power may be selected to lower the temperature to the TM range as quickly as possible. Thus, at step 705, Q is set to Qₘₐₓ for this range, which is the maximum cooling rate as defined by the physical constraints of the system, typically given by component upper speed/torque/current limitations or heat exchanger size constraints. In the next step 720, the RPM for the motor and fan speed demand signals 585,580 is determined to achieve the selected Q value, i.e. Qₘₐₓ, for a given evaporating pressure (P_{evaporating}) and condensing pressure (P_{condensing}). Here a lookup map is used to convert Q to RPM values (as discussed further below). These demand signals are fed to the compressor motor controller 70 and the fans 30a,34a to control their operation. Alternatively, the fan speed may be calculated based on the pressure drop over the evaporator coil, rather than the evaporating and condensing pressures. As the coil ices up the pressure drop will increase requiring a higher fan speed to blow the same amount of air for the same amount of cooling power.

In the “Temperature Maintenance” TM range, there is no requirement to cool at a given pace as the rate of temperature decrease (the slope of the curve) is mostly irrelevant and what is important is the (near) constant average overall rate of heat removal. As illustrated by FIG. 7, the algorithm proceeds by selecting at step 710 the optimum Qₙₑₜ value from the table between Qₘₐₓ and Qₘᵢₙ for the prevailing sensed values of P_{evaporating} and P_{condensing}. Thus, referring to the example of Table 1 above, any of the values 10 kW, 7.5 kWh and 5 kW are candidates for selection as Q. It is found from the table that Q=7.5 kWh has the highest value of sCoPₙₑₜ, and so is selected as the optimum Qₒₚₜ at that point in time. As the temperature decreases further, another Qₒₚₜ is selected because the prevailing pressures have changed. It will be appreciated that in practical example, the table used is likely to be more granular, having more values of Qₙₑₜ, as well as having Qₙₑₜ values for different pressure combinations. In the next step 720, the RPM demand signals 580,585 are selected for the Qₒₚₜ value using the a look up table, i.e. in the same way as used in FIG. 7A.

In the above example, the Temperature Maintenance mode is engaged when the Hysteresis Upper Bound is reached for the first time. Alternatively, Temperature Maintenance mode may be engaged when the Hysteresis Lower Bound is reached the first time, or indeed at any point within the Upper and Lower Bounds, rather than when the Upper Bound is reached. This means that Qₘₐₓ is maintained for longer when the temperature is being pulled down, as this may be desired by the operator to satisfy food temperature, as even when the air temperature in the compartment has reached the desired set point, the load and walls of the compartment may not yet have reached thermal equilibrium and still be relatively warm and at this stage meaning that additional cooling power is temporarily beneficial before entering maintenance mode to help pull down the load and walls.

The operator may manually place the system in pulldown mode, or this may happen automatically when the system is switched on or triggered by an external events, such as the doors opening. Alternatively, this may be triggered automatically by the system upon detection of the temperature in the compartment being above the upper bound. Similarly, maintenance mode may be triggered automatically when the temperature moves between the upper and lower bounds or by the operator.

As shown by FIG. 7C, the system may optionally also use Qₘᵢₙ control in the “Temperature Maintenance” TM range to ensure the temperature remains below the Hysteresis Upper Bound by requesting sufficient cooling at all times. This generally works in the same way as the algorithm of FIG. 7B where a value of Qₒₚₜ is chosen from the candidate Q values in the table between Qₘᵢₙ and Qₘₐₓ. An additional step 730 is first performed to dynamically adjust the Qₘᵢₙ value to exclude candidate Q values that provide insufficient cooling. This avoids unwanted temperature rises above the upper bound.

FIG. 8 shows a control process for adjusting Qₘᵢₙ for use with the algorithm of FIG. 7C. The error between the set point temperature and the actual measured temperature in the compartment is found at step 810. This is fed to a cooling demand controller 820, for instance proportional-integral-derivative (PID) controller or any other control strategy with a control loop feedback mechanism, to output a Q_{demand} signal. At step 830, the maximum of the Qₘᵢₙ and the Q_{demand} signal is determined, and used to dynamically override the original Qₘᵢₙ signal which is used in place of the original Qₘᵢₙ value in looking up the Qₒₚₜ value in step 710. Thus, if the actual temperature in the compartment starts to drift upwards compared to the set point, a higher Q_{demand} signal overrides Qₘᵢₙ, whereas if the actual temperature drifts downwards, then a lower Qₘᵢₙ value overrides Qₘᵢₙ accordingly. Thus, in the scenario described above, where the walls of the container take longer to pull down to the set point temperature, Qₘᵢₙ may be overridden by a higher value at first, to provide additional cooling whilst the walls reach equilibrium, before reverting to a lower value.

Thus, the overall control algorithm determines an optimised cooling power demand signal Qₒₚₜ value within bounds determined primarily by cooling need and secondarily by optimum efficiency when a range of values are allowed and then converts it to a speed demand. This has the advantage of allowing the Qₒₚₜ value to be directly targeted to create optimum efficiency for the system as a whole, and then for this optimum value to be converted to the motor speed demand. In contrast, prior art control schemes typically target motor speed demand directly and so do not have the capability of optimising the cooling demand based on overall predetermined values of system efficiency. Speed control is an indirect control method with a non-linear relationship to the physical thermal system being controlled. Cooling power demand control is a direct control method with a linear relationship to the physical thermal system being controlled. The benefit from Q control opposed to RPM control is that Q control allows controlling a property that impacts the system consistently in its complete operating envelope. e.g. Compressor motor speed does not scale linearly with the amount cooling delivered and is very dependent on prevailing temperatures. An increase of, say, 1000 RPM motor speed has a very different impact at, say, −20° C. compared to at, say, 0° C., making it difficult to control temperature based on motor speed. In contrast, a given cooling power has the same impact at any temperature and so by controlling the cooling demand value directly, before converting to a required speed for the prevailing conditions, better results are achieved, The preferred method also allows step changes in optimised cooling power demand Qₒₚₜ throughout the hysteresis control loop, which may be frequently calculated, e.g. many times per second and so effectively continuously. Finally, having a separate control strategy to control the minimum Q value dynamically guards against insufficient cooling demand being selected according to the prevailing conditions.

Reciprocating compressors typically have multiple cylinders and some have the ability to disengage a proportion of the cylinders, e.g. typically 50%, to reduce the volume flow rate and so to reduce capacity. So instead of changing the speed at which the compressor is driven by half (to halve the volume flow rate), the number of cylinders are halved to result in half the cooling. Similarly overall compressor capacity may be adjusted by having plural compressors and engaging different numbers of compressors to adjust the cooling, e.g. engaging one out of two available compressors to half the cooling. The technique of engaging different numbers of cylinders within a compressor may be combined with engaged different numbers of available compressors to achieve even finer granularity in adjusting the cooling power.

FIG. 9 shows controls logic to implement a control algorithm suitable for use with such compressor(s) which provides a way of regulating compressor motor speed based on various compressor capacities. It selects a suitable capacity (based on a pre-populated map) and a matching speed depending on prevailing pressures. There is a speed map for each discrete capacity option. In the present example, the compressor has four cylinders, two of which can be switched off simultaneously providing two discrete capacity options: two cylinders and four cylinders. Accordingly, there would be two respective RPM lookup maps for the two capacity options. It will be appreciated that in other examples there may be more or fewer capacity options, i.e. for different numbers of cylinders and/or different numbers of compressors engaged, each with a respective RPM lookup map.

In practice, these maps could be combined in a single table, such that a single RPM look up based on cooling demand, condensing pressure and evaporating pressure gives two outputs, namely the capacity and the RPM for the compressor with only valid numbers populated. However, this can result in issues related to looking up the speed when transitioning across from low to high and high to low capacity. Having two separate RPM maps can help avoid RPM interpolation error in the transition range between the capacities.

The capacity selection map is populated using simulations and algorithms described below. This control algorithm may be used in combination with the control strategy described above in relation to FIG. 7 or with different control strategies.

In more detail, first, at step 920, a cooling demand Q is dynamically determined. This can use the optimised cooling demand Qₒₚₜ value determined in FIGS. 7B or 7C.

In other examples, the cooling demand may be determined in other ways, such as by finding the error between the set point temperature Tₛₚ and the actual measured temperature T in the compartment and feeding this error back to a cooling demand feedback controller, for instance a proportional-integral-derivative (PID) controller, to output a cooling demand signal Q_{demand} that provides an optimum cooling demand, e.g. cooling demand is throttled back as the error reduces towards zero and the actual temperature approaches the set point temperature.

However the cooling demand is determined, at step 930, the cooling demand Q_{demand} is used to look up a compressor capacity in a capacity selection map. This is a table mapping Q_{demand} to one of the available compressor capacities, e.g. 100% or 50% capacity, which is determined to be optimum for each of a range of values of the prevailing evaporating pressure P_{evaporating} and Condensing pressure P_{condensing}. Similarly to the Qₒₚₜ lookup tables/maps in FIGS. 7a-c, the maps can be found by testing or modelling the system, and are preferably specific to a particular refrigeration unit and its parameters.

The output of this step is a capacity control signal fed to the compressor(s) to select the determined capacity, i.e. to engage the determined number of cylinders and/or engage the determined number of compressors.

At step 940, the cooling demand value Q_{demand} is used to look up from a table RPM demand values for the compressor and fans for particular prevailing values of the evaporating and condensing pressures. This is similar to the step 720 in the control schemes of FIG. 7a-c, except that here the map that is used depends on the determined capacity. The demand signals are then fed to the compressor(s) and fans to control their operation.

### Pressure Filtering Logic

As shown by FIG. 10, the pressure measurements 110 and 120 can optionally be filtered 105 with a moving average filter or any other suitable filter to provide averaged values 160,150 before being used in looking up values in the tables/maps 710, 720 in FIGS. 7a-c and 930, 940 in FIG. 9. Additionally or alternatively, this can be limited to only incorporate pressure values from when the system is running 130 and not when the system is turned off 140. This helps reject noise and fluctuations in the measurements and prevent sudden changes in the values looked up in the maps.

### RPM Lookup Map

The RPM lookup map (or matrix) 720,940 converts a desired cooling power to a matching compressor speed RPM and is used in both algorithms depicted respectively in FIGS. 7a-c and 9. This allows the algorithms to control the cooling power directly and indirectly translate it to RPM depending on prevailing pressures. This is beneficial due to a number of reasons:
1) The amount of cooling is highly dependent of pressures. For example at a low evaporating pressure the compressor may have to operate at 2000 RPM to deliver 10 kW cooling whilst at a much higher evaporating pressure 1000 RPM is sufficient. Controlling cooling allows the controller to modulate cooling which is physically linked to temperature changes.
2) Upper and lower cooling power bounds can be applied. This is important because the refrigeration system is sized to operate within a defined cooling power range. The relationship to RPM is much more abstract.
3) This allows suitable fan speed to be determined for appropriate air flow independently of the determination of the cooling required, and so there is more freedom to select appropriate values for fan speeds.

In each case, the RPM lookup maps typically requires 3 inputs and produces at least 1 output. The three inputs are:
1) Evaporating pressure (or equivalent evaporating temperature) or, alternatively, the controlled temperature
2) Condensing pressure (or equivalent condensing temperature) or, alternatively, the ambient temperature
3) Cooling demand

The output is the compressor motor speed demand, here in Revolutions Per Minute (RPM), although any units could be used. Preferably, a fan speed demand is also output for controlling the fans.

Multiple RPM maps may be produced to convert cooling demand to RPM at various cylinder capacities. Capacity selection can be used to select a suitable map as shown in the control algorithm of FIG. 9.

### Capacity Selection Map

The capacity selection map requires the same inputs as the RPM map, but outputs a binary to engage/disengage compressor cylinders and/or compressors and select an appropriate RPM speed map for that output.

### Lookup Map Construction

Both capacity and RPM maps can be construction in two ways.
1) Testing. A large quantity of steady state tests can be conducted to produce an array of speed measurements for all combinations of a) Condensing Pressure, b) Evaporating Pressure, c) Cooling power and d) Capacity.

It can be seen that even if only 3 variations of each of the 4 parameters is selected a total number of 3×3×3×3=81 tests are needed. This is laborious and so in some scenarios option two below might be preferred.
2) Simulation by building a mathematical model of the refrigeration cycle, and simulating all combinations. In principle, the control software could model the refrigeration cycle in real time to produce the output values, and so avoid having a look up table. But this is computationally expensive and so it is generally preferred in most cases to have a look up table.

FIG. 11 shows an example of a partial data set which has been produced either by testing or modelling. For each combination of values of capacity, evaporating pressure, condensing pressure and cooling demand, values of coefficient of performance CoP, compressor speed and torque are specified. Once a data set such as the data set shown below has been produced the capacity selection map may be constructed in two steps.

As shown by FIG. 12, the first step is to loop through every line item in the results table and allocate in a 3D matrix.

This produces two RPM maps (RPM_half and RPM_full) for either full capacity with all cylinders (or all compressors) engaged or half capacity for half of the cylinders (or half of the compressors) engaged. Equally torque maps and CoP maps for various cylinder (or compressor) engagement configurations can be produced.

The second step is to build the Capacity Map with a selection logic, again testing all combinations which are now halved as they are split into two different RPM maps (5760/2=2880 combinations). In the present example, the following logic is applied:

Select Full Capacity when
Full Capacity Torque is lower than maximum torque and Full Capacity RPM is greater than Minimum RPM
OR
Half Capacity RPM is greater than maximum speed at Half Capacity

In all other cases, select Half Capacity

Other types of selection logics can be used based on other metrics. The following alternative uses CoP:

Select Full Capacity when
the CoP at Full Capacity is higher than the CoP at Half Capacity
AND
the Full Capacity RPM is greater than the minimum RPM allowed.

In all other cases, select Half Capacity

In the above logics, maximum torque, maximum and minimum speeds are determined by the physical parameters of the system, e.g. the manufacturers datasheet for the compressor will specify a maximum allowed/recommended torque.

A graphic representations of a capacity map using the first example is shown by FIGS. 13a-13c. This shows RPM demand at various condensing temperatures. Full capacity is selected when Full capacity torque is <=34 Nm (the maximum torque) AND Full Capacity RPM>=800 (minimum RPM) OR Half Capacity RPM>=2600 (maximum RPM at half capacity). The grey area is full capacity and the white are is half capacity. NB, the Figures show evaporating and condensing temperature which correlates to Evaporating and condensing pressure in the examples above.

### Nomenclature

The cooling power can be either the Net (incl. fan heat dissipation) er Gross (excl. fan heat dissipation)

| Physical | Nomenclature | Unit | Description |
|---|---|---|---|
| Net Cooling | Qₙₑₜ | kW | Rate of cooling power taking into account the |
| Power | | | heat dissipated by the fans |
| Max Net | Qₘₐₓ | kW | |
| Cooling | | | |
| Power | | | |
| Min Net | Qₘᵢₙ | kW | |
| Cooling | | | |
| Power | | | |
| Optimum | Qₒₚₜ | kW | |
| Cooling | | | |
| Power | | | |
| Pull-down | PD | — | Undesired temperature range above Tᵤₚₚₑᵣ |
| | | | that the refrigeration must “pull down” through |
| | | | to get to the desired temperature range TM |
| Temperature | TM | — | Desired temperature range where all |
| maintenance | | | temperatures satisfy payload requirements. |
| | | | The range is bounded by Tᵤₚₚₑᵣ |
| | | | and T_{lower} making TM |
| Hysteresis | Tᵤₚₚₑᵣ | ° C. | |
| Upper | | | |
| Bound | | | |
| Hysteresis | T_{lower} | ° C. | |
| Lower | | | |
| Bound | | | |
| Set-point | Tₛₚ | ° C. | User temperature setting. The upper and |
| | | | lower bounds are derived from this value |
| | | | using fixed offsets. |

Embodiments of the present invention have been described with particular reference to the examples illustrated. However, it will be appreciated that variations and modifications may be made to the examples described within the scope of the present claims.

1. A computerised method of controlling a vapour compression cycle system arranged to cool and or heat a compartment, the method comprising:
dynamically determining a cooling or heating power demand value for the system based at least in part on monitoring the temperature in the compartment to be cooled or heated by the system and comparing it with a required set point temperature;
converting the power demand value to a speed demand value according to a predetermined model or map and according to prevailing values of evaporating pressure and condensing pressure, or the equivalent temperature values;
sending the speed demand value to a compressor motor speed controller of the system.

2. The method of claim 1, wherein the power demand value is selected from a plurality of predetermined discrete values.

3. The method of claim 1, wherein the power demand value is dynamically chosen from a plurality of possible power demand values according to prevailing values of evaporating pressure and condensing pressure or equivalent temperature values and according to a measure of efficiency calculated for each candidate power demand value.

4. The method of claim 3, comprising:
in a temperature maintenance mode, using hysteresis control of the system to maintain the temperature in a range between upper and lower temperature bounds that are at predetermined offsets from a required set point temperature, wherein, if the compartment is to be cooled, the cooling is switched on using the speed demand value when the temperature rises to the upper bound and switched off when the temperature falls to the lower bound and, if the compartment is to be heated, the heating is switched on using the speed demand value when the temperature falls to the lower bound and switched off when the temperature rises to the upper bound.

5. The method of claim 4, comprising:
if the compartment is to be cooled, in a temperature pulldown mode, cooling with a fixed and/or maximum power demand value, wherein temperature pulldown mode is used before entering the temperature maintenance mode; and
if the compartment is to be heated, in a temperature pullup mode, heating with a fixed and/or maximum power demand value, wherein the temperature pull up mode is used before entering the temperature maintenance mode.

6. The method of claim 3, comprising using a look up table of calculated or measured values to find the most efficient candidate power demand value for given values of evaporating pressure or condensing pressure or the equivalent temperature values.

7. The method of claim 1, wherein the candidate power demand values are selected between predetermined minimum and maximum values.

8. The method of claim 7, wherein the minimum power demand value is dynamically recalculated according to the difference between the set point temperature and actual temperature such that a higher value is selected where the difference is greater.

9. The method of claim 8, wherein a feedback control scheme is used to adjust the minimum value.

10. The method of claim 1, comprising converting the power demand value to a fan speed demand value according to a predetermined model or map and according to prevailing values of evaporator coil pressure drop; and
controlling at least one fan of the system according to the fan speed demand value.

11. The method of claim 1, wherein a moving average filter is applied to pressure readings or equivalent temperature readings before choosing the power demand value and/or the pressure readings are only used when the system is switched on.

12. The method of claim 1, wherein the system comprises a compressor that can operate in at least a first and second capacity, the method comprising:
using the power demand value and sensed values of evaporating pressure and condensing pressure or equivalent temperature values to output via a lookup table to an optimum compressor capacity;
output a control signal to cause the compressor to implement the selected optimum compressor capacity.

13. The method of claim 12, wherein the lookup table is constructed such that capacity is selected based on comparing a one or more values selected from compressor speed, system coefficient of performance and torque with predefined maximum and/or minimum values.

14. The method of claim 13, wherein either
(A) full capacity is selected when:
the full capacity torque is lower than maximum torque and full capacity speed is greater than minimum speed
or
half capacity speed is greater than maximum speed at half capacity and otherwise half capacity is selected; or
(B) full capacity is selected when:
the coefficient of performance at full capacity is higher than the coefficient of performance at half capacity
and
the full capacity speed is greater than the minimum speed allowed and otherwise half capacity is selected.

15. (canceled)

16. The method of claim 12, comprising selecting a look up table for the selected compressor capacity from a plurality of look up tables for respective plural different compressor capacities, wherein each lookup table maps power demand values to compressor speed values and using that lookup table to select an output compressor speed signal to feed to the compressor motor speed controller.

17. A computerised method of controlling a vapour compression cycle system arranged to cool and or heat a compartment, the method comprising:
monitoring the temperature in the compartment to be cooled or heated by the system;
in a temperature maintenance mode, using hysteresis control of the system to maintain the temperature in a range between upper and lower temperature bounds that are at predetermined offsets from a required set point temperature, wherein the power demand value used is dynamically chosen from a plurality of possible power demand values according to prevailing values of evaporating pressure and condensing pressure or equivalent temperature values and according to a measure of efficiency calculated for each candidate power demand value.

18. The method of claim 17, comprising:
if the compartment is to be cooled, in a temperature pulldown mode, cooling with a fixed and/or maximum cooling power demand value, wherein temperature pulldown mode is used before entering the temperature maintenance mode; and
if the compartment is to be heated, in a temperature pullup mode, heating with a fixed and/or maximum heating power demand value, wherein the temperature pull up mode is used before entering the temperature maintenance mode.

19. The method of claim 17, comprising using a look up table of calculated or measured values to find the most efficient candidate power demand values for given values of evaporating pressure or condensing pressure.

20. The method of claim 17, wherein the candidate power demand values are selected between predetermined minimum and maximum values and wherein the minimum value is dynamically recalculated according to the difference between the set point temperature and actual temperature such that a higher value is selected for the minimum power demand value where the difference is greater.

21. A computerised method of controlling a vapour compression cycle system arranged to cool and or heat a compartment, the method comprising:
determining a cooling or heating power demand value;
point
selecting a compressor capacity value by looking up a compressor capacity in a look up table according to prevailing evaporating and condensing pressures or their equivalent temperatures and the determined power demand value;
causing the compressor to operate in accordance with control signals comprising the compressor capacity value and power demand value.

22. The method of claim 21, comprising:
monitoring the temperature in the compartment to be cooled or heated by the system;
comparing the temperature to a required set point temperature;
using a demand controller to determine the cooling or heating power demand value based on feeding back the difference between the monitored temperature and set point temperature configured to reduce the difference.

23. The method of claim 21, wherein the power demand value is dynamically chosen from a plurality of possible power demand values according to current prevailing values of evaporating pressure and condensing pressure or equivalent temperature values and according to a measure of efficiency calculated for each candidate power demand value.

24. The method of claim 21, comprising converting the power demand value to a speed demand according to the compressor capacity value.

25. The method of claim 24, wherein a lookup table is used to map power demand values to speed demand values wherein the table is indexed by the power demand value, the capacity, and prevailing evaporating and condensing pressures or their equivalent temperatures.

26. The method of claim 21, wherein the look up table values are generated by modelling the system or by testing.

27. A refrigeration unit, transport refrigeration unit or heat pump comprising a vapour compression cycle system and a system controller arranged to perform the method of claim 1.

28. (canceled)

29. A refrigeration unit, transport refrigeration unit or heat pump comprising a vapour compression cycle system and a system controller arranged to perform the method of claim 16.

30. A refrigeration unit, transport refrigeration unit or heat pump comprising a vapour compression cycle system and a system controller arranged to perform the method of claim 20.
